(19) United States
(12) Patent Application Publication
(10) Pub. No.: US 2016/0210442 A1
(43) Pub. Date: Jul. 21, 2016

(54) METHOD AND SYSTEM FOR DETERMINING THE EFFECTIVENESS OF PATIENT QUESTIONS FOR A REMOTE PATIENT MONITORING, COMMUNICATIONS AND NOTIFICATION SYSTEM

(71) Applicant: Discharge IQ, Inc., Roswell, GA (US)

(72) Inventors: Matthew Jay Ethington, Roswell, GA (US); Eric Otto Eschenbach, Marietta, GA (US)

(21) Appl. No.: 14/994,428

(22) Filed: Jan. 13, 2016

Related U.S. Application Data
(60) Provisional application No. 62/104,840, filed on Jan. 18, 2015.

(51) Int. Cl. G06F 19/00

(52) U.S. Cl. CPC G06F 19/363; G06F 19/327

(57) ABSTRACT

A patient monitoring system to automate remote care management and to reduce hospital readmissions for disease state management, patient health and wellness, medication adherence, and clinical care coordination; includes component for patient self-reporting and monitoring devices, component for patient/care team communications, component for care team time tracking and billing, component for creating, scoring, scheduling, assigning, and trialing questionnaires, component for work list, prioritizing and ranking of patients, and component for notification alerts to entire clinical care team: nurses, doctors, patient, caregivers, and patient advocates.

### CROSS REFERENCE TO RELATED PATENT APPLICATION

This application claims priority to and benefit of U.S. Provisional Application No. 62/104,840 filed Jan. 18, 2015, herein incorporated by reference in its entirety.

### BACKGROUND

America's healthcare system is under pressure to reduce costs and improve outcomes. Hospitals, in particular, face a multitude of challenges ranging from Federal and State mandates that assess penalties for excessive readmissions to changes in reimbursement rates based on patient results instead of flat fee for service preformed. To overcome these challenges, hospitals are looking for affordable solutions that reduce readmissions by keeping patients effectively monitored after discharge from a hospital stay. The invention provides a solution for hospitals by addressing the following 3 major areas of concern:

Chronic Disease Management: One in two Americans suffer from a chronic disease. Chronic diseases account for 7 out of 10 deaths in the United States and 75% of healthcare costs due to complexity of care. Remote monitoring of previously discharged patients gives hospitals an affordable and efficient way to manage chronic disease patients. The invention introduces an advanced system to create, manage, and optimize remote monitoring questionnaires, which reduces the cost of care coordination and increases patient compliance with treatment plans.

Reduced Readmissions: In 2014, 20% of hospitalized patients over the age of 65 who are discharged must be re-hospitalized within 30 days, costing $26 Billion annually. The invention provides tools for patients, clinicians, and hospitals to monitor discharged patients during their recovery period so appropriate outpatient treatment can be administered before the patient deteriorates to the point of requiring hospital readmission.

Care Transition: After discharge, patients are given several directives to complete to help with recovery, including scheduling follow-up visit(s) with doctor(s), starting treatment plans (including medications), and making lifestyle changes. In many cases, patients do not understand or cannot remember discharge instructions. Failure to adhere to discharge instructions is one of the major causes of patient readmission. The invention decreases the occurrence of these problems by remotely monitoring patient health and post-discharge compliance by using configurable questionnaires that provide prioritized, direct feedback and communications with the patient's care team while allowing the patient to review discharge instructions and interact with the clinical care team.

### SUMMARY

The present invention includes a method and system for remote patient monitoring to automate care management and reduce readmissions. The system centers on adjustable, periodic questionnaires that patients complete on their computer or smart devices. Questionnaires are composed of one or more questions, a scoring algorithm for each question, and a schedule to determine when patients should respond to questions. For each monitoring period, patients are presented a set of questions, depending on the questionnaire's schedule, and responds to those questions. Responses can be self-reported answers to questions manually entered by the patient or caregiver, measurements automatically provided by monitoring devices, or manually entered measurements from unconnected monitoring devices.

The scoring component receives responses from patients or caregivers and then scores the questionnaire. For each patient, the system maintains state-machine logic for the patient, the specific questionnaires assigned to the patient, and the inclusive set of questions available to patient. The responses, response scores, and patient history are inputted to the state-machines for each period of patient monitoring. Based on the resulting response scoring, state-machines, and patient history, the scoring component enables follow-up questions. The scoring component also updates questionnaire assignments and scheduling as needed. The scoring module then generates an aggregate score for each period of patient monitoring.

The system provides tools to determine the effectiveness of individual questions, and questionnaires. Individual questions can be enhanced to include one or more variation. Question variants can be compared against results of other variants, either using side-by-side trials (A/B, multi-variant testing) or benchmarking results of previous trials. During a side-by-side trial period, question variants are randomly selected when presenting to specific patients. As trials progress, the system tracks the variants and their responses and provides analysis to determine which variant has a stronger correlation to patient health and whether those patients get readmitted to the hospital.

The system includes a work list component that ranks patients based on the results of aggregate scores to prioritize patients within a care teams' follow-up work list. The specific work list for each member of the care team is used to review patient information, review patient responses using interactive charts, contact patients, update patient information, and modify patient questionnaire assignments and scheduling. The work list component updates work lists in real-time as patients submit responses and periodically updates the work list for non-responsive patients in order to give priority to certain patients for follow-up intervention.

The system has an alert component, which uses scoring and work list components, to generate alerts to patients, caregivers, clinical care team members and/or patient advocates. Alerts can be configured to be sent via email, app-notifications, internal system messages, text messages, chat messages or any form of electronic communications. The alert component can be specifically configured to match the needs of a patient or institution's requirements.

Questionnaires, specific questions, question variants, scoring, scheduling, state-machine logic, and alert triggers are all data driven and configurable. The system provides graphical user interfaces for the clinical care team to design and manage all aspects of patent monitoring. A reporting component provides data mining analysis for de-identified patient population segments. The system also has an application program interface (API) component for integrating data with other electronic medical systems and devices, including EMR (Electronic Medical Record) software. The API component can receive data from remote systems, by exposing end-points, and push data to remote systems.

In one embodiment of the system, patients use smart devices, such as smart phones, tablets, or portable personal electronic devices (like smart watches) to access an app that periodically presents questionnaires. The app has graphical user interfaces for entering self-reporting responses and the ability to connect with monitoring devices for performing quantitative measurements on the patient (such as, but not limited, to blood pressure, weight, and SpO2/blood oxygen levels). The app also automatically retrieves information gathered by the smart device, such as an accelerometer or GPS, which can be used as additional sets of measurements. An alarm is integrated into the app to notify patients when it is time to answer questionnaires.

In another embodiment, patients use web sites from desktop or laptop computers that periodically present their questionnaires. The web sites have graphical user interfaces for entering self-reporting responses.

A third embodiment is when patients use monitoring devices that independently connect to the system or can be independently queried by the system. For example, as patients use their personal monitoring devices, measurements are transferred to system. Monitoring devices include, but aren't limited to, blood pressure cuffs, weight scales, and oxygen saturation devices.

Finally, an embodiment of the system is the care team contacting the patient using any means to collect responses and enter them on behalf of the patient. The most common means for collecting information is telephone calls, but other can be included, such as text messaging and chat messaging. Multiple devices can also be employed to ensure complete response to questionnaires.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1 illustrates a computer system embodiment that implements the functionality of the current invention;

FIG. 2 is a flow chart for an embodiment of the invention showing the interaction between the patient and the monitoring system;

FIG. 3 is a flow chart for an embodiment of the invention showing the lifecycle of question, variants, and questionnaire trials;

FIG. 4 is a flow chart for an embodiment of the invention showing the interactions between scoring, scheduling, and state-machine feedback for a monitoring period;

FIG. 5 is a flow chart for an embodiment of the invention showing the detailed interactions of the scoring module; and

FIG. 6 is a block diagram illustrating an exemplary operating environment for performing the disclosed methods.

### DETAILED DESCRIPTION

Before the present methods and systems are disclosed and described, it is to be understood that the methods and systems are not limited to specific synthetic methods, specific components, or to particular compositions. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Disclosed and described herein are embodiments of an advanced, automated remote patient monitoring system 101.

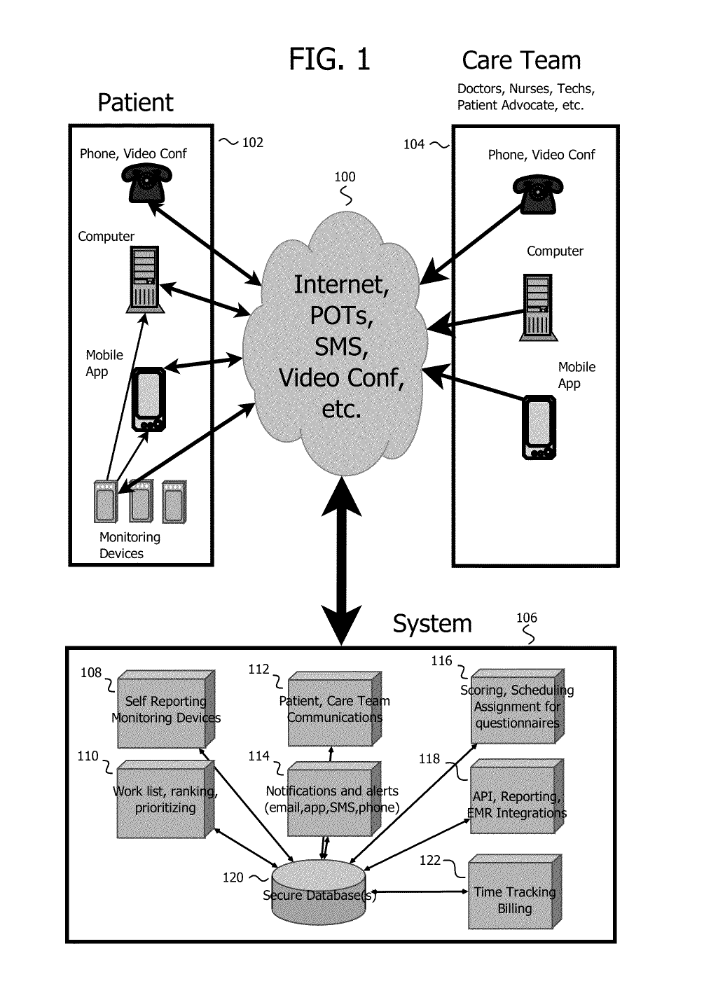

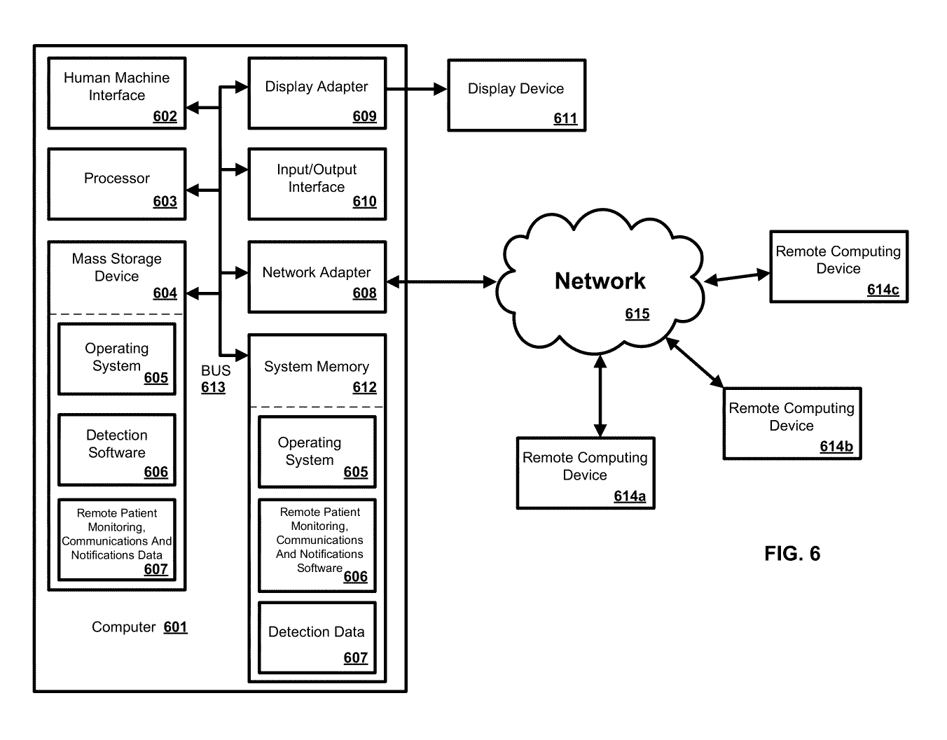

FIG. 1 illustrates various network interactions in a remote patient monitoring and notification system 101 according to one exemplary embodiment. In FIG. 1, computer system 106 includes web based graphical interfaces, application program interface (API)-based interfaces, and network access 100 for all forms of communications (Internet, text, remote API call, video conferencing, plain old telephone service (POTs), etc.), computer processors, and persistent, secure databases. In one aspect, the computer system 106 can be hosted within a cloud data center, locally on the premise of a hospital/clinic, or with standard PC(s). It is to be appreciated that computer system 106 can be comprised of one or more computers such as the computer described herein in reference to FIG. 6. Further, if comprised of multiple computers, it is to be appreciated that the computers may be located together or remotely. In one aspect, the computer system 106 may be cloud hosted. Though cloud hosting may be the preferred method, how the computer system 106 is hosted is independent of the invention and therefore flexible. Network access 100 is used by patients and caregivers to interact with the system 106. Patients or caregivers can use any type of electronic access depending on availability, accessibility, or personal preference. Common forms of patient communications devices 102 are, for example, smart phones or tablets using app(s), computer using web site(s), connected patient monitoring devices, text messaging (SMS), phones, video conferencing, and the like. Further, aspects of the disclosure are not limited to these forms of communications and can accommodate any present and future forms of electronic communications. Further comprising the embodiment of FIG. 1 is a care team 104. The care team 104, which can include doctors, nurses, technicians, and patient advocates (such as family members or social workers), and the like, can use similar forms of communications with the system 106 as the patient communications devices 102. The common forms can include smart phones or tablets using app(s) and computer using web site(s), but the care team 104 may also use phone, video conferencing, text messaging, etc., for communicating with system 106 and patient communications devices 102.

The components described herein are one embodiment of the invention. While components are high-level constructs of the system 101 and are helpful for visualizing the system it is to be appreciated that the system is not constrained to these components and features/functionality of the system can span several components. Each component has access to network access 100 and secure databases 120, which are at least Health Insurance Portability and Accountability Act of 1996 (HIPAA) and Health Information Technology for Economic and Clinical Health (HITECH) Act complaint. All components are available for internal interactions within the system and, for simplicity of the diagram, FIG. 1 omits these interactions. The various components of the system are accessible via web sites, smart device apps, command line tools, APIs, and the like.

In one aspect, periodic questionnaires are completed by patients or caregivers with results being received by the system 106. Monitoring periods (the time period between questionnaires being received by a particular person) are adjustable per questionnaire and per recipient and can be, for example, daily, bi-daily, weekly, etc., or changed to meet any specific period of time. Questionnaire prompting for a patient continues until the monitoring duration is complete, the patient deceases, or patient is reassigned a new questionnaire. Generally, monitoring begins after the patient has seen a healthcare provider or upon discharge from a healthcare facility. The typical duration for monitoring is 30 to 60 days; however, the system 101 allows for any duration to be specified and the care team can terminate monitoring at any point (for example if the patient fully recovers). Questionnaires contain one or more questions, each of which can be scheduled independently within the monitoring duration. Questions can be formatted in several types based on the required response: multiple choices, yes/no, numeric, multiple-numeric, free-form text, uploading images, and data from monitoring devices. The system 101 is not limited to these question types and can be expanded to accommodate other forms without changing the nature of the disclosed embodiments. An example of an image question response is to take a picture of a wound on the patient from which assessments can be made. Monitoring devices may come in many different measurement formats, all of which can be accommodated by the system 101.

Referring to FIG. 1, interface device 108 comprises a portion of the computer system 106. Interface device 108 is responsible for graphical interfaces to present questions to patients and the collection of responses, in the form of self-reported answers or measurements from monitoring devices. Self-reported answers are for subjective questions, such as “how are you feeling today?”, or objective questions, such as “have you completed a follow-up appointment with your primary care doctor since being discharged from the hospital?” Subjective questions are difficult to obtain responses using monitoring devices, so the patient answers these questions directly (self-reported) by completing a form via patient communications devices 102. For objective questions, such as “what is your blood pressure?” or “what is your weight?”, the patient can respond using connected monitoring devices or answer questions by manually entering measurements from an unconnected monitoring device (self-reported). Monitoring devices can connect to the system by posting measurements directly to the API component 118, by providing an API that the API component 118 queries for measurements or by smart device apps that query monitoring devices and post measurements to the system. For example, the monitoring device may connect wirelessly (e.g., Bluetooth) to a patient's smartphone and the posted measurements transmitted from the measuring device to the smartphone and to the system 101.

The computer system 106 further comprises a scheduler component 116, which schedules questions, scores responses, and maintains patient condition (including state machine logic), patient history, and response history. This component 116 uses feedback from previous responses given by a specific patient for scheduling and scoring. An example is monitoring the weight of a patient: when scoring the response for a given monitoring period, the patient's weight from previous periods is examined to determine the rate at which a patient is gaining or losing weight. Patient condition and history are also used for scheduling and scoring. An example is monitoring the shortness of breath for a patient: when determining whether or how often to ask this question, the patient's condition is used (does the patient have asthma?; was the patient sort of breath yesterday?; etc.). When scoring responses, questions with state-machine logic are updated. Scheduling uses the state-machine logic for determining when to ask specific questions for a patient, including asking follow-up questions within a monitoring period. The system allows both cascading questions and logic-trees for state-based questions. An example is monitoring follow-up appointments: questions are presented to the patient depending on static machine logic: 1) Pre-Scheduled: asks “have you scheduled an appointment?”, 2) Scheduled: asks “have you been to appointment?” 3) Complete: asks “is another appointment is needed?”, etc. For a monitoring period, an aggregate score is generated per patient. For example, the score may be in a range of 0-100, with 100 being the worst. The system, however, is adjustable and can use any range defined per questionnaire. The aggregate score is composed from the scores for each response within the monitoring period. Response scores can be weighted differently to emphasize responses with a stronger correlation to failing health. Patient condition, patient history, and response history can also be used when generating the aggregate score.

Scheduler component 116 may also use questionnaire trials to determine which variants of questions to ask to patients. Patient condition and demographics can be used to group patients into population segments, which are mapped to variants of questions. In many cases, small subsets of the patient populate can be used to trial question variants. Variants can be as simple as changing the order of multiple choice responses to as complicated as varying the types of questions. Questionnaire trials are optional, as the system can be used without them. However, trials can be used to optimize patient monitoring and better serve the patient by more quickly identifying patient with issues.

User interface component 110, which also comprises the computer system 106, provides user interfaces for the clinical care team to interact with the system 106. It can include interfaces for configuration of questionnaires (specific question choices, question variants, scheduling, and scoring), managing care team members, managing patients, and the like. Patient management has interfaces to review responses with interactive charts, contact patients, update patient information, and modify patient questionnaire assignments and scheduling. Patient management interfaces can also include a work list dashboard that ranks patients based on the results of scoring to prioritize patients within the care teams' work list. First, individual patients are assigned to members of a care team. The assignment can be done automatically by the system, based on patient condition and/or based on care team work load. An example is a clinic with nurses with different specialties: the system assigns patients based on diagnosis that matches nurses' specialty. Second, a work list of patients is maintained by the system for each member of the care team. The list is updated in real-time and prioritized based on the results of scoring (both aggregate and whether patients have triggered alerts). Then, during a specified monitoring period for a patient, the work list tracks interactions between the care team and the patient. The care team uses this list to prioritize their work when contacting patients with problems. As the care team contacts patients using 112, they can alter treatment instructions for the patient to improve outcomes. In one aspect, the system 106 can be used for logging comments for changes in treatment and notations on patient health. These comments can be overlaid on graphs of patient responses to determine correlation of changes in treatment with changes with patient health. The system provides a work list component to track when the care team is contacted, who contacted the patient, and any documentation from the contact. As patients are contacted by care team, the work list is reprioritized by pushing the completed contacted patients to the bottom of the list. The work list component for patients is reset at the beginning of their monitoring period.

The computer system can further be comprised of a communication component 112. Component 112 provides means for communication between patients and their care teams. Communication can be initiated by either the patient or a member of the care team. The system facilitates communications using the method preferred by the patient including email, SMS text messages, video conferencing, phone, or any other electronic method of communications. Each patient can be contacted using their preferred method of communication. Component 112 manages the patient preferences and can create connections on request from the patient, caregiver, or care team. For email and SMS text message, the system transmits patient data in a manner to assure data integrity and maintain compliance with privacy laws and guidelines such as HIPAA. For example, the system can send links to secure web pages for exchanging personal medical information, assuring data security is maintained at all times. For phone conversations, the system can integrate with PBX solutions for calling patients with a click from a web page or smart device app. For video conferencing, the system can integrate with providers such as Skype™, Facetime™, etc. for connecting patients or caregivers and the care team with a single click from a web page or smart device app. The system can also provide for messages within the system, which are accessed via web pages and smart device apps. In some aspects, this provides greater security and confidentiality as third-party communications providers are systems are not used. While these examples of communication may be the most common form of communications utilized by embodiments of the system 101, it is to be appreciated that the system 101 is not limited to the exemplary forms of communication and contemplates the use of any electronic form of communications.

The computer system 106 may also comprise an alert component 114, which uses scoring and work list components, to generate alerts to patients, care team members and/or patient advocates. Alerts can use any means provided by the communication component 112, depending on patient or care team preferences. The system 106 generates alerts during monitoring periods based upon questionnaires. Alerts are triggered whenever patient responses are outside of the normal, safe range and sent to the care team for triage. The normal, safe range is configured on each question and can be customized per patient. An example of customized alert range is monitoring blood pressure, which varies widely between patients. Patients with a low baseline can trigger alerts at different ranges than patients with normal or high baselines. The system 106 can also generate alerts when patients have not responded during a monitoring period. These alerts can be sent to patients, caregivers, and the care team. For non-responsive patients, alerts may be specifically targeted to the patient's caregiver or advocate, such as their spouse or adult-children, to investigate on patient's ability to respond.

Further comprising the computer system 106 can be a reporting/API component 118. In one aspect, the reporting component 118 can provide analytics for de-identified patient data. Using common data mining techniques, this information can be analyzed to further refine question trials, to measure monitoring effectiveness, and to refine scoring of questions. With standard questionnaires, hospitals and clinics can compare their results to others within the system to help identify areas for improvement, which will be used to further improve the effectiveness of the monitoring system. Component 118 can also provide APIs for integrating with other electronic medical systems, particularly electronic medical record (EMR) software. As patients are discharged from the hospital, the API can either receive or query for patient records to import into the system's database and assigns questionnaires based on diagnoses. The API can also integrate with various patient monitoring devices.

As the care team interacts with the system, component 122 categorizes every action and tracks in database 120. Actions include anything done by care team via the user interface like mouse clicks/touches, typing, retrieving/submitting data, viewing web pages, log in/out, etc. Using the reporting/API component 118, the system can also track the care teams' actions from remote systems such as EMRs. The system 106 can provide a user interface for the care team to manually track time from non-integrated systems or offline actions like phone calls and paper-based review of patients. Each actions from the care team is tagged with the affected patients so that time can be correlated with specific patients. The system can tag multiple patients for an action, such as when reviewing the work list dashboard 110. The system 106 can track all log-ins and log-outs by care team, to obtain boundaries for duration of activities, with log-outs automatically occurring when care team stops interacting with the system. After the information is collected, the system 106 can calculate the time spent on every patient in the system by comparing timestamps of subsequent actions and grouping all actions tagged for specific patients. On a periodic basis, typically monthly, the reporting component 118 can generate a report that can be used for time-base monitoring of patients. Within the report, thresholds can be set, for example 20 minutes per month, which are used to determine which patients can be billed. The report includes the day of the month in which monitoring exceeds the billing threshold, the threshold excess, etc.

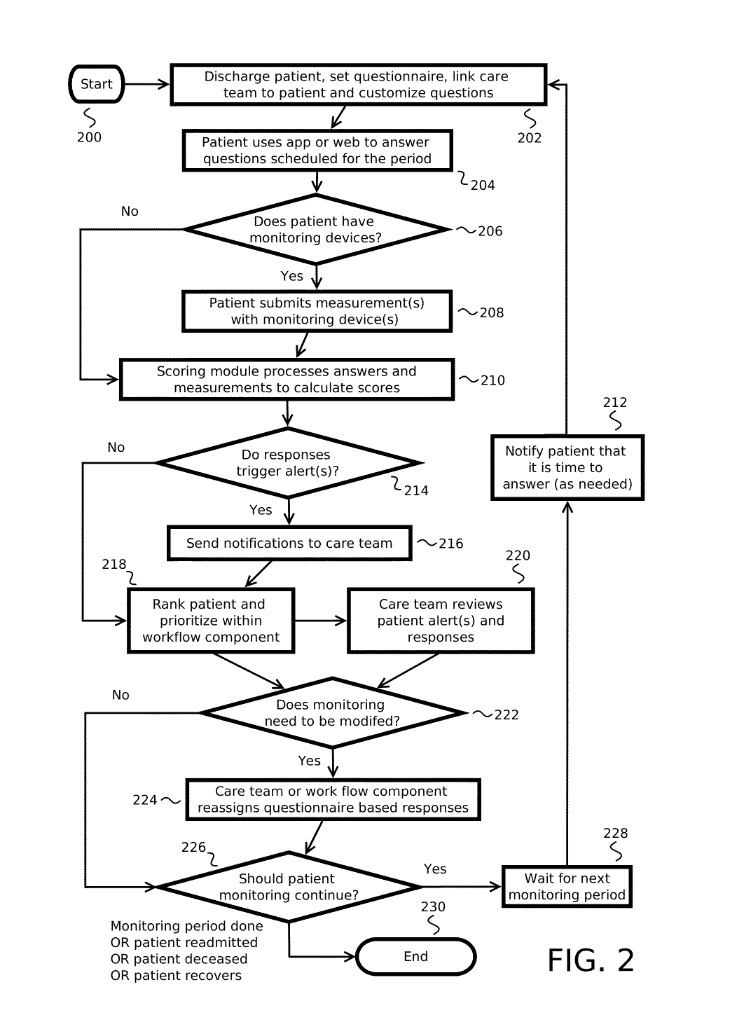

FIG. 2 is a flowchart that illustrates an exemplary process for a patient monitoring period. The process illustrated in FIG. 2 can be at least partially implemented on the system described with reference to FIG. 1. The start 200 of patient monitoring occurs when patient data enters into the system, usually after discharge from the hospital or admittance to a clinic. During initial setup 202, the patient is assigned a care team, including patient advocates (guardians, family, and/or caregivers) and all information for contacting the care team is logged. The setup process assigns a questionnaire for the patient and customizes the questions for that patient, including alert ranges and scoring thresholds. Customization of questions include many aspects of patient information, such as baseline weight, demographics (age, gender, race), and primary and secondary diagnoses. Also during setup, patients are given secure, HIPAA compliant accounts to access the system from the web and smart device apps.

During the monitoring period, the system sends reminder notices to patients 212 that it is time enter responses for the period. The time of this reminder can be set to individual patient preferences and needs. When the patient interacts with the system 204, the system presents the questions that are scheduled for that specific period. The patient responds to questions using smart device apps or using websites. If the patient has a connected monitor device(s) 206, patient submits measurements 208 by using said devices. Connected monitor devices can include, for example, a blood pressure measurement device, a weight measurement device, a glucose monitoring device, a pulse oximeter, a peak flow meter, a breathalyzer, a pedometer, a thermometer, and the like. When the system receives responses 210, they are scored and patient history is updated. The system checks responses 214 and determines if any are out of individualized normal bounds. If so, then alert(s) 216 are generated and sent to the care team. The system also prioritizes the patient 218 within the care team's work list so they receive attention before patients with normal responses.

When care team receives alerts 220, the system highlights the patients needing attention and the responses that triggered the alerts by placing them at the top of the work list and label them with an alert icon on the work list. The system and care team examine alerts to determine if monitoring needs to be modified 222. The care team can also communicate with the patient to alter treatment and to further understand the patient's condition. Using state-machine logic, the system can automatically reassign the patient to different questionnaires 224. The care team also has the option 224 to reassign monitoring questionnaires manually. Typically this occurs when patients reach milestones in their recovery (either positive or negative) and a different questionnaire becomes more appropriate. Finally, the system determines 226 whether monitoring should continue. If monitoring is complete, patients are placed in a completed state 230, the patient history is updated and the reason why monitoring is complete is stored. Patients can complete monitoring by reaching the end of the monitoring period, by getting readmitted to the hospital, by death, or by full recovery. When placed in a completed state, the patient is removed from the care team's work list and is archived in the system. If monitoring should continue, the system waits 228 for the next monitoring period; starting the cycle over (212 and 202). Archived patients are kept on file for HIPAA and Medicare compliance, but are no longer part of the work list component.

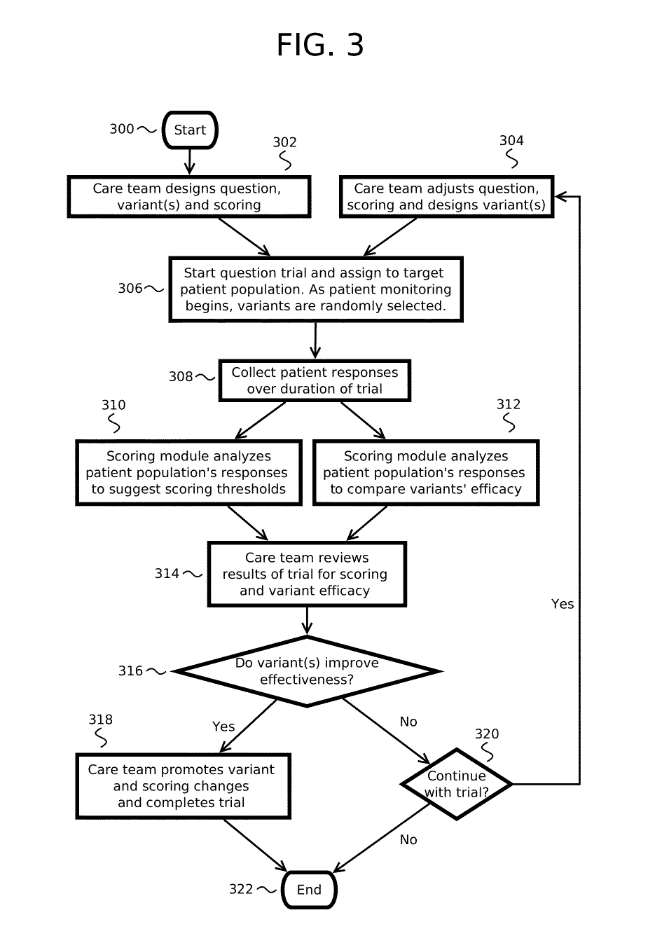

FIG. 3 is a flowchart that illustrates a process for questionnaire trials. Trials are used for measuring the effectiveness of questions. Specifically, trials help optimize language used when asking a question, order of responses (for multiple choice questions), scoring ranges, and scheduling of questions. The process illustrated in FIG. 3 can be at least partially implemented on the system described with reference to FIG. 1. The system provides a means for trialing variants of individual questions and variants of questionnaires. When running trials, two or more variants are compared against each other with regards to the health of the patients monitored using the different variants, such as reductions in symptoms, medication adherence, laboratory values within normal ranges, reductions in doctor visits, percent of full recovery, percent of deceased, percent of readmission, and percent of monitoring complete. Other aspects can be used when determining the effectiveness of a trial, such as how many man-hours of the care team are used, patient compliance (how many patient participate with monitoring), and how quickly the monitoring identified those patients needing intervention. As trails progress, the system stores all of the data points 120 and provides reports 118 that the clinical care team uses when determining effectiveness of variants.

The trial process begins 300 when the care team decides to trial an aspect of their patient monitoring. The care team builds 302 variants which will be trialed against either baseline results from previous trials or from other active variants (side-by-side). After building the desired variants, the care team designates 306 the population segment(s) to participate with trials. Population segments can be all or a subset of patients based on patient diagnosis, condition, and/or demographics. Trials can be limited by absolute number of participants, which is beneficial for creating baseline results. Baseline results of a trial allow for multiple and subsequent trials of the same questionnaire/questions over time. When trialing against baseline results, the system randomly selects patients of the designated population segment and presents questions from variants being trialed. While trialing variants against each other (side-by-side), the system randomly selects patients within the designated population segments and assigns specific variants. In both types of trials, the system collects 308 patient responses and tracks patient health. The system stops adding new patients to trial when desired number of patients has been reached or care team manually stops trials.

As patients participate in trials, the scoring module analyzes 310 responses and creates suggestions for scoring thresholds, using standard data-mining and machine learning techniques. The clinical care team can use suggestions to further refine questions and trials if warranted. The system also analyzes 312 results of trials in real-time to compare effectiveness of changes made between variants. The clinical care team reviews 314 results and suggestions from trials and determines 316 how to proceed. If the trail improved the results of patient monitoring, then the clinical team promotes 318 variants and scoring changes to replace previous versions for questions/questionnaires. When variants are promoted, the trial is considered complete 322. In the case where the trial did not improve results, the care team evaluates 320 whether to continue with trials. If more trials are desired, care team adjusts 304 question variants and/or scoring and starts 306 the trails again. If care team is done with trials, then no additional trials are created and normal monitoring resumes 322.

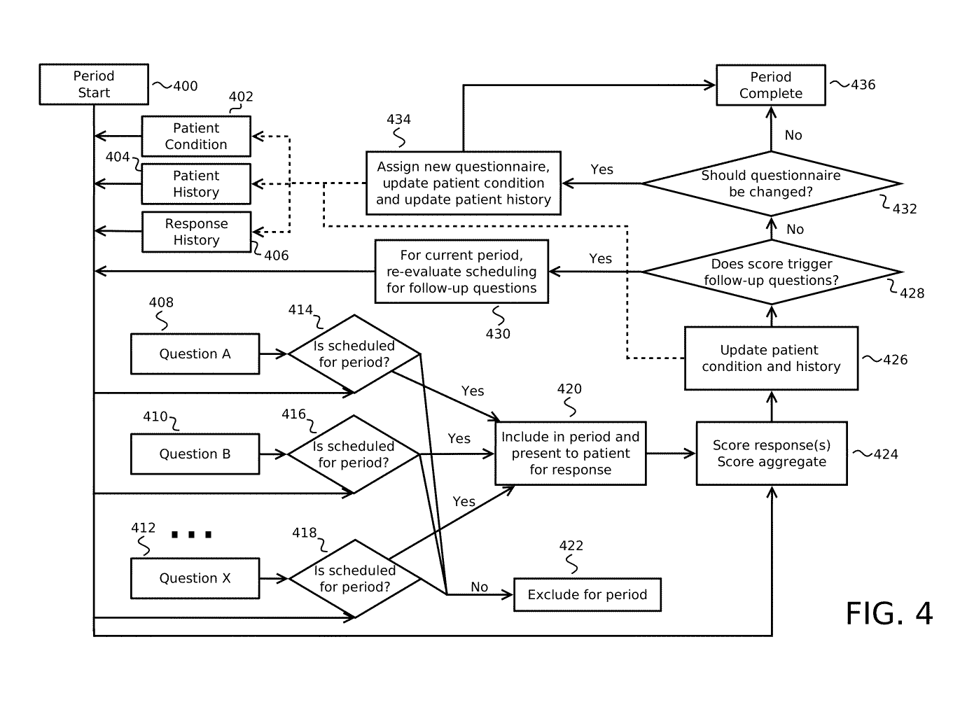

FIG. 4 is a flowchart that illustrates interactions of question scheduling and scoring. The process illustrated in FIG. 4 can be at least partially implemented on the system described with reference to FIG. 1. When monitoring periods begin 400 for patients, the scheduling component determines 414, 416 and 418 which questions should be presented to patients, which are selected from the questionnaires assigned to patients. Based on the scheduling for questionnaires, different questions 408, 410 and 412 can be presented to patients for different monitoring periods. Questions can be scheduled as periodic, one-time, range of times, or state-based (cascading and logic trees). When determining which questions to include in a period, the system uses patient condition 402, patient history 404, and response history 406. This provides feedback to the scheduling component so that state-based questions are appropriately scheduled. Cascading questions are used to capture a series of responses from the patient. Logic-trees can also be scheduled within the system to generate more complex questionnaires. An example of logic tree scheduling is for heart failure monitoring: A) Do you have swelling in your hands or feet? B) Are you short of breath? C) Are you having tightness or pain in your chest? In this example, question A is always asked to patients. If A is answered “no”, then question B and C are skipped. If A is answered “yes”, then question B is presented to patient within the same monitoring period. If B is “yes”, then an alert is triggered. If B is “no”, then the system will present question C to patient within the same period and trigger alert if “yes” to question C.

When the scheduling component determines the set of questions, the system presents 420 the questions and collects patient responses. Questions that are excluded 422 for period will be re-evaluated to determine if responses trigger the excluded questions. When the scoring component receives patient responses, they are scored 424. The results from scoring are used to update 426 patient condition 402, patient history 404, and response history 406. The scheduling component then determines 428 whether follow-up questions should be presented to patients. When making determination for follow-up questions, the patient response, scoring, and history are used. If any additional questions are needed, the scheduling component re-evaluates 430 questionnaire scheduling and presents the follow-up questions immediately to patients while they interact with the system. The system also examines whether responses fall too far outside of expected ranges (for example 1 or 2 standard deviations) and, if so, immediately prompts the patient to review and verify responses. Once all responses are received for period and no additional follow-up questions are needed, the system checks 432 if patient monitoring questionnaire should be switched. To determine if a change is required, the system examines patient history, patient condition, and response history. An example is when monitoring total hip or knee replacement: if the system determines that a patient potentially has an infection, then patients are changed to a different questionnaire tailored to their new conditions. Another example is when a patient is diagnosed with additional diseases or conditions. In this case, the care team updates the patients' condition (or the system automatically updates via the API) and the system reassigns patients to more appropriate questionnaires. When questionnaires are changed 434, the system updates patient condition and patient history. After all updates are finished, monitoring period 436 is complete.

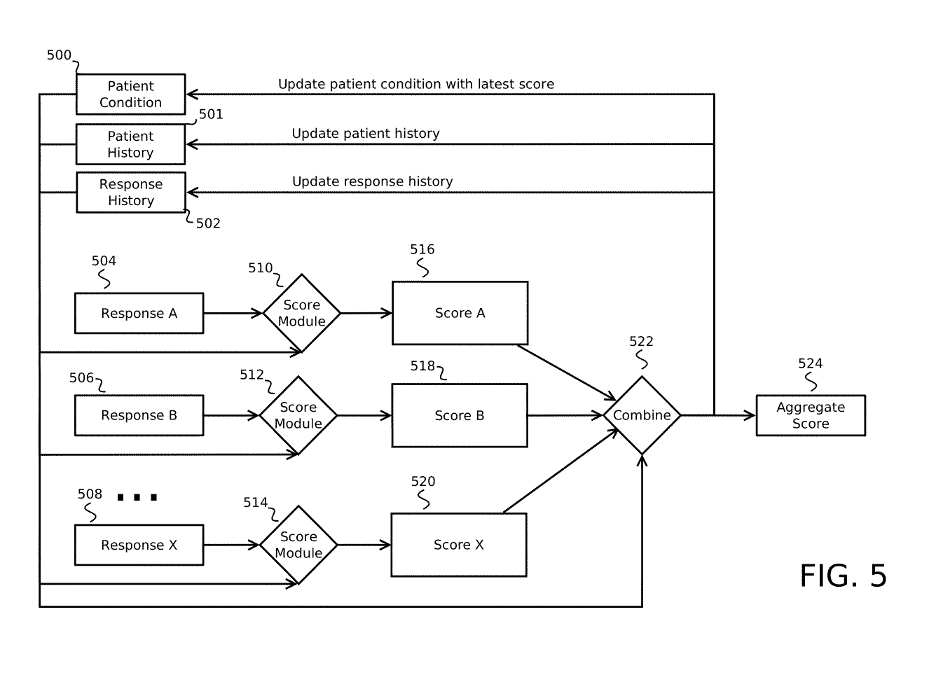

FIG. 5 is a flowchart that shows the interactions between the scoring module and different data sets. The process illustrated in FIG. 5 can be at least partially implemented on the system described with reference to FIG. 1. The scoring module 510, 512 and 514 uses patient responses 504, 506 and 508, patient condition 500, patient history 501, and response history 502. All data inputs are used when determining the scores 516, 518 and 520. Each response is scored on a scale as defined by individual care teams. Any numeric range is possible within the system with the typical range of 1-5, with 1 as the best and 5 as the worst. Scores can be either whole or fractional numbers, depending on configuration of questions. The system tracks the score for every response and combines 522 them to generate a single aggregate score 524 per monitoring period. The scoring component weighs responses based on their relative weighting and on the number of responses for the period, since the scheduling component can present variable numbers of questions per period. The scoring component then updates the patient condition 500, patient history 501, and response history 502 with all scores for the period.

The aggregate score 524 uses a configurable algorithm and range based on a specific questionnaire. The typical range is 0-100 with 100 as the worst score and 0 as the best. The system provides a built-in algorithm for converting 1 or more response scores into an aggregate score. The clinical care team can define custom algorithms or use the built-in algorithm per questionnaire. The built-in algorithm is a non-linear function that combines response scores so that any single alert (i.e. 5 response score) results in a score above 70.

The system has been described above as comprised of units. One skilled in the art will appreciate that this is a functional description and that the respective functions can be performed by software, hardware, or a combination of software and hardware. In some instances, a unit can be software, hardware, or a combination of software and hardware. The units can comprise the remote patient monitoring, communications and notifications software 606 as illustrated in FIG. 6 and described below. In one exemplary aspect, the units can comprise a computer 601 as illustrated in FIG. 6 and described below.

FIG. 6 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well-known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computer 601. The components of the computer 601 can comprise, but are not limited to, one or more processors or processing units 603, a system memory 612, and a system bus 613 that couples various system components including the processor 603 to the system memory 612. In the case of multiple processing units 603, the system can utilize parallel computing. As used herein, “processor” 603 is a hardware device that is a part of the computer 601, such as the central processing unit, that performs calculations or other manipulations of data in accordance with instructions provided to the processor. Generally, the instructions comprise machine-executable code.

The system bus 613 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 613, and all buses specified in this description can also be implemented over a wired or wireless network connection and each of the subsystems, including the processor 603, a mass storage device 604, an operating system 605, remote patient monitoring, communications and notifications software 606, remote patient monitoring, communications and notifications data 607, a network adapter 608, system memory 612, an Input/Output Interface 610, a display adapter 609, a display device 611, and a human machine interface 602, can be contained within one or more remote computing devices 614a,b,c at physically separate locations, connected through buses of this form, in effect implementing a fully distributed system. In one aspect, remote computing devices can comprise smart devices, such as smart phones, tablets, or portable personal electronic devices (like smart watches) used by patients and/or the care team to access the computer system 601.

The computer 601 typically comprises a variety of computer readable media. Exemplary readable media can be any available media that is accessible by the computer 601 and comprises, for example and not meant to be limiting, both volatile and non-volatile media, removable and non-removable media. The system memory 612 comprises computer readable media in the form of volatile memory, such as random access memory (RAM), and/or non-volatile memory, such as read only memory (ROM). The system memory 612 typically contains data such as remote patient monitoring, communications and notifications data 607 and/or program modules such as operating system 605 and remote patient monitoring, communications and notifications software 606 that are immediately accessible to and/or are presently operated on by the processing unit 603.

In another aspect, the computer 601 can also comprise other removable/non-removable, volatile/non-volatile computer storage media. By way of example, FIG. 6 illustrates a mass storage device 604 which can provide non-volatile storage of computer code, computer readable instructions, data structures, program modules, and other data for the computer 601. For example and not meant to be limiting, a mass storage device 604 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 604, including by way of example, an operating system 605 and remote patient monitoring, communications and notifications software 606. Each of the operating system 605 and remote patient monitoring, communications and notifications software 606 (or some combination thereof) can comprise elements of the programming and the remote patient monitoring, communications and notifications software 606. Remote patient monitoring, communications and notifications data 607 can also be stored on the mass storage device 604. Remote patient monitoring, communications and notifications data 607 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 601 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 603 via a human machine interface 602 that is coupled to the system bus 613, but can be connected by other interface and bus structures, such as a parallel port, game port, an IEEE 1394 Port (also known as a Firewire port), a serial port, or a universal serial bus (USB).

In yet another aspect, a display device 611 can also be connected to the system bus 613 via an interface, such as a display adapter 609. It is contemplated that the computer 601 can have more than one display adapter 609 and the computer 601 can have more than one display device 611. For example, a display device can be a monitor, an LCD (Liquid Crystal Display), or a projector. In addition to the display device 611, other output peripheral devices can comprise components such as speakers (not shown) and a printer (not shown) which can be connected to the computer 601 via Input/Output Interface 610. Any step and/or result of the methods can be output in any form to an output device. Such output can be any form of visual representation, including, but not limited to, textual, graphical, animation, audio, tactile, and the like.

The computer 601 can operate in a networked environment using logical connections to one or more remote computing devices 614a,b,c. By way of example, a remote computing device can be a personal computer, portable computer, a server, a router, a network computer, a peer device or other common network node, and so on. Logical connections between the computer 601 and a remote computing device 614a,b,c can be made via a local area network (LAN) and a general wide area network (WAN). Such network connections can be through a network adapter 608. A network adapter 608 can be implemented in both wired and wireless environments. Such networking environments are conventional and commonplace in offices, enterprise-wide computer networks, intranets, and the Internet 615.

For purposes of illustration, application programs and other executable program components such as the operating system 605 are illustrated herein as discrete blocks, although it is recognized that such programs and components reside at various times in different storage components of the computing device 601, and are executed by the data processor(s) of the computer. An implementation of remote patient monitoring, communications and notifications software 606 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications are referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method for testing the effectiveness of questions used in a remote patient monitoring, communications and notification system comprising:
develop a trial question;
develop one or more variants of the trial question;
designate population segments to participate in trials of the trial question and its one or more variants;
send the trial question and its one or more variants to the designated population segment;
receive responses to the trial question and its one or more variants from the designated population segment;
score the received responses to the trial question and its one or more variants based on a scoring methodology that considers improvements in patient monitoring;
compare effectiveness of changes made between the trial question and its one or more variants; and
promote the trial question or a variant of the trail question that improved the results of patient monitoring.

2. The method of claim 1, wherein comparing effectiveness of changes made between the trial question and its one or more variants comprises comparing two or more question variants against each other with regards to health of the patients monitored using the different variants.

3. The method of claim 2, wherein health of the patients monitored using the different variants considers one or more of reductions in symptoms, medication adherence, laboratory values within normal ranges, reductions in doctor visits, percent of full recovery, percent of deceased, percent of readmission, and percent of monitoring complete.

4. The method of claim 1, wherein comparing effectiveness of changes made between the trial question and its one or more variants comprises considering how many man-hours of a care team are used, patient compliance (how many patients participate with monitoring), and how quickly the monitoring identified those patients needing intervention.

5. The method of claim 4, wherein comparing effectiveness of changes made between the trial question and its one or more variants comprises considers comparing an effectiveness of intervention by the care team for the trial question and its one or more variants.

6. The method of claim 5, wherein comparing the effectiveness of intervention by the care team for the trail question and its one or more variants comprises considering one or more of methods of intervention used by the care team including phone calls, doctor visits, emails, texts, medication changes, and diet changes based on responses to the trail question and its one or more variants.

7. The method of claim 5, wherein comparing an effectiveness of intervention by the care team for the trial question and its one or more variants further comprises comparing effectiveness of individual care team members compared to one another.

8. The method of claim 1, wherein scoring the received responses to the trial question and its one or more variants based on a scoring methodology that considers improvements in patient monitoring comprises testing the trial question and its one or more variants against either baseline results from previous trials or comparing results of the trial question and its one or more variants in a side-by-side comparison.

9. The method of claim 1, wherein designating population segments to participate in trials of the trial question and its one or more variants comprises designating population segments comprised of all or a subset of patients based on patient diagnosis, condition, and/or demographics.

10. The method of claim 9, wherein when testing the trial question and its one or more variants against baseline results, the trial question or one of its variants is presented to randomly selected patients of the designated population segment

11. The method of claim 9, wherein when comparing results of the trial question and its one or more variants in a side-by-side comparison, patients are randomly selected within the designated population segments and specifically assigned the trial question or one of its variants.

12. The method of claim 9, wherein testing the trial question and its one or more variants against either baseline results from previous trials or comparing results of the trial question and its one or more variants in a side-by-side comparison comprises collecting a patient's responses and tracking the patient's health.

13. The method of claim 9, wherein comparing results of the trial question and its one or more variants in a side-by-side comparison comprises analyzing responses and creating scoring thresholds for triggering alerts for each of the trial question and its one or more variants and determine effectiveness of monitoring based on the scoring thresholds for triggering alerts.

14. A system for testing the effectiveness of questions used in a remote patient monitoring, communications and notification system comprising:
a patient communications device; and
a computer system in communication with the patient communications device, wherein the computer system comprises a processor and a memory with computer-executable instructions thereon, said computer-executable instructions executed by the processor to:
develop a trial question;
develop one or more variants of the trial question;
designate one or more population segments to participate in trials of the trial question and its one or more variants;
send the trial question and its one or more variants to a patient communication device of each of one or more patients that comprise the one or more designated population segments;
receive responses to the trial question and its one or more variants from the designated population segment via the patient communication devices;
score the received responses to the trial question and its one or more variants based on a scoring methodology that considers improvements in patient monitoring;
compare effectiveness of changes made between the trial question and its one or more variants; and
promote the trial question or a variant of the trail question that improved the results of patient monitoring.

15. The system of claim 14, wherein comparing effectiveness of changes made between the trial question and its one or more variants comprises comparing two or more question variants against each other with regards to health of the patients monitored using the different variants.

16. The system of claim 15, wherein health of the patients monitored using the different variants considers one or more of reductions in symptoms, medication adherence, laboratory values within normal ranges, reductions in doctor visits, percent of full recovery, percent of deceased, percent of readmission, and percent of monitoring complete.

17. The system of claim 14, wherein comparing effectiveness of changes made between the trial question and its one or more variants comprises considering how many man-hours of a care team are used, patient compliance (how many patients participate with monitoring), and how quickly the monitoring identified those patients needing intervention.

18. The system of claim 17, wherein comparing effectiveness of changes made between the trial question and its one or more variants comprises considers comparing an effectiveness of intervention by the care team for the trial question and its one or more variants.

19. The system of claim 18, wherein comparing the effectiveness of intervention by the care team for the trail question and its one or more variants comprises considering one or more of methods of intervention used by the care team including phone calls, doctor visits, emails, texts, medication changes, and diet changes based on responses to the trail question and its one or more variants.

20. The system of claim 18, wherein comparing an effectiveness of intervention by the care team for the trial question and its one or more variants further comprises comparing effectiveness of individual care team members compared to one another.

21. The system of claim 14, wherein scoring the received responses to the trial question and its one or more variants based on a scoring methodology that considers improvements in patient monitoring comprises testing the trial question and its one or more variants against either baseline results from previous trials or comparing results of the trial question and its one or more variants in a side-by-side comparison.

22. The system of claim 14, wherein designating population segments to participate in trials of the trial question and its one or more variants comprises designating population segments comprised of all or a subset of patients based on patient diagnosis, condition, and/or demographics.

23. The system of claim 22, wherein when testing the trial question and its one or more variants against baseline results, the trial question or one of its variants is presented to randomly selected patients of the designated population segment

24. The system of claim 22, wherein when comparing results of the trial question and its one or more variants in a side-by-side comparison, patients are randomly selected within the designated population segments and specifically assigned the trial question or one of its variants.

25. The system of claim 22, wherein testing the trial question and its one or more variants against either baseline results from previous trials or comparing results of the trial question and its one or more variants in a side-by-side comparison comprises collecting a patient's responses and tracking the patient's health.

26. The system of claim 22, wherein comparing results of the trial question and its one or more variants in a side-by-side comparison comprises analyzing responses and creating scoring thresholds for triggering alerts for each of the trial question and its one or more variants and determine effectiveness of monitoring based on the scoring thresholds for triggering alerts.

27. A non-transitory computer storage media having computer-executable instructions stored thereon which, when executed by a computer, cause the computer to:
develop a trial question;
develop one or more variants of the trial question;
designate population segments to participate in trials of the trial question and its one or more variants;
send the trial question and its one or more variants to the designated population segment;
receive responses to the trial question and its one or more variants from the designated population segment;
score the received responses to the trial question and its one or more variants based on a scoring methodology that considers improvements in patient monitoring;
compare effectiveness of changes made between the trial question and its one or more variants; and
promote the trial question or a variant of the trail question that improved the results of patient monitoring.
